(19) United States
(12) Patent Application Publication
(10) Pub. No.: US 2026/0259592 A1
(43) Pub. Date: Sep. 3, 2026

(54) INFORMATION PROCESSING APPARATUS AND CONTROL METHOD

(71) Applicant: Lenovo Japan LLC, Tokyo (JP)

(72) Inventors: Masashi Nishio, Kanagawa (JP); Kyohei Futami, Kanagawa (JP); Keisuke Arai, Kanagawa (JP)

(73) Assignee: Lenovo Japan LLC, Tokyo (JP)

(21) Appl. No.: 19/456,445

(22) Filed: Jan. 22, 2026

(30) Foreign Application Priority Data
Mar. 3, 2025 (JP) 2025-032982

(51) Int. Cl. G06F 1/3231; G06F 1/3234; G09G 5/00

(52) U.S. Cl. CPC G06F 1/3231; G06F 1/3265; G09G 5/003; G09G 2330/022

(57) ABSTRACT

An information processing apparatus includes: a communication unit configured to perform data communication with a server through a communication network; a memory configured to temporarily store a program of a system; a processor configured to execute processing of the system based on the program stored in the memory; and a detection sensor configured to detect presence or absence of a person in a predetermined detection range. When the system becomes a standby state, the processor transmits a flag indicative of being on the standby state from the communication unit to the server through the communication network. When acquiring an execution request for specific processing from the server in response to transmitting the flag, the processor starts execution of the specific processing.

### CROSS-REFERENCE TO RELATED APPLICATIONS

This application claims priority to Japanese Patent Application No. 2025-032982 filed on Mar. 3, 2025, the contents of which are hereby incorporated herein by reference in their entirety.

### TECHNICAL FIELD

The present invention relates to an information processing apparatus and a control method.

### BACKGROUND

There is technology to execute AI processing using cloud AI (Artificial Intelligence) built on the cloud (for example, see Japanese Patent No. 7559930). In order to use cloud AI for work, since there are obstacles such as the risk of information leakage and high cost, commercial use may be limited. For example, since considerable resources are required to run a heavy task (heavy-load processing) such as a large language model (LLM) on a local PC (Personal Computer), it is difficult to process the task on an operating PC.

However, even when text being generated is interrupted halfway through, since the large language model (LLM) can generate the rest of the text, the large language model (LLM) can be executed on plural PCs while taking over the processing. Therefore, there is a method of executing a heavy task on plural PCs while taking over processing to a PC where no work is being done due to the absence of a user among the plural PCs.

However, in a case where processing such as the large language model (LLM) is being executed on a PC where no work is being done due to the absence of a user, when the user comes back and starts working, there is a concern that processing may slow down due to insufficient resources for processing the user wants to perform because a heavy task such as the large language model (LLM) is being executed from the start until another PC takes over the task. For example, when the returning user starts using the PC by performing keyboard input or the like, since the transition to control for interrupting the heavy task such as the large language model (LLM) can be made only after the user touches the keyboard, processing slows down at the start of the work.

The present invention has been made in view of the above circumstances, and it is an object thereof to provide an information processing apparatus and a control method capable of reducing the impact on performance when locally executing heavy-load processing.

### SUMMARY

An information processing apparatus according to the first aspect of the present invention includes: a communication unit configured to perform data communication with a server through a communication network; a memory configured to temporarily store a program of a system; a processor configured to execute processing of the system based on the program stored in the memory; and a detection sensor configured to detect the presence or absence of a person in a predetermined detection range, wherein when the system becomes a standby state, the processor transmits a flag indicative of being on the standby state from the communication unit to the server through the communication network, when acquiring an execution request for specific processing from the server in response to transmitting the flag, the processor starts execution of the specific processing, and when the presence of a person is detected in the detection range using the detection sensor while executing the specific processing, the processor stops the execution, and transmits, from the communication unit to the server through the communication network, an execution result before the stop and incomplete information indicating that the specific processing is incomplete.

The above information processing apparatus may be such that, when the presence of a person is detected in the detection range using the detection sensor while not executing the specific processing, the processor resets the flag.

The above information processing apparatus may also be such that, when the presence of a person is detected in the detection range using the detection sensor while executing the specific processing, the processor causes the system to return from the standby state after stopping the execution, and resets the flag.

The above information processing apparatus may further include a display unit configured to perform display based on processing of the system, wherein when causing the system to transition to the standby state, the processor turns off a screen of the display unit, and when causing the system to return from the standby state, the processor turns on the screen of the display unit.

The above information processing apparatus may further be such that, when the presence of a person is detected in the detection range using the detection sensor, the processor further determines whether or not a face of the person is facing a specific direction, when determining that the face of the person present in the detection range is not facing the specific direction, the processor transmits the flag to the server after causing the system to transition to the standby state, and when determining that the face of the person present in the detection range is turned in the specific direction while executing the specific processing, the processor causes the system to return from the standby state after stopping the execution.

The above information processing apparatus may further include a display unit configured to perform display based on processing of the system, wherein the specific direction is a direction to the information processing apparatus, when causing the system to transition to the standby state, the processor reduces the screen brightness of the display unit, when causing the system to return from the standby state, the processor restores the screen brightness of the display unit to screen brightness before being reduced.

Further, the above information processing apparatus may be such that the specific processing is relatively heavy-load processing and can be executed on a plurality of information processing apparatuses while taking over halfway processing in response to the execution request from the server.

Further, a control method for an information processing apparatus according to the second aspect of the present invention is a control method for an information processing apparatus including: a communication unit configured to perform data communication with a server through a communication network; a memory configured to temporarily store a program of a system; a processor configured to execute processing of the system based on the program stored in the memory; and a detection sensor configured to detect the presence or absence of a person in a predetermined detection range, the control method including: a step of transmitting a flag indicative of being on standby from the communication unit to the server through the communication network when the system becomes a standby state; a step of starting execution of the specific processing when acquiring an execution request for specific processing from the server in response to transmitting the flag; a step of stopping the execution when the presence of a person is detected in the detection range using the detection sensor while executing the specific processing; and a step of transmitting, from the communication unit to the server through the communication network, an execution result before the stop and incomplete information indicating that the specific processing is incomplete.

The above aspects of the present invention can reduce the impact on performance when locally executing heavy-load processing in accordance with one or more embodiments.

### BRIEF DESCRIPTION OF THE DRAWINGS

FIG. 1 is a configuration diagram for describing the overview of an information processing system according to one or more embodiments.

FIG. 2 is a flowchart illustrating an example of processing in the information processing system according to one or more embodiments.

FIG. 3 is a perspective view illustrating a configuration example of the appearance of an information processing apparatus according to one or more embodiments.

FIG. 4 is a diagram illustrating an example of a person detection range of the information processing apparatus according to one or more embodiments.

FIG. 5 is a diagram for describing an overview of HPD processing of the information processing apparatus according to one or more embodiments.

FIG. 6 is a diagram illustrating an example of screen brightness reduction processing according to one or more embodiments.

FIG. 7 is a schematic block diagram illustrating an example of the hardware configuration of the information processing apparatus according to one or more embodiments.

FIG. 8 is a schematic block diagram illustrating an example of the functional configuration of the information processing apparatus according to one or more embodiments.

FIG. 9 is a timing chart illustrating an example of control by a processing unit according to one or more embodiments.

FIG. 10 is a flowchart illustrating an example of host processing in the information processing apparatus according to one or more embodiments.

### DETAILED DESCRIPTION OF THE INVENTION

Embodiments of the present invention will be described below with reference to the accompanying drawings.

### Overview

First, the overview of an information processing system according to one or more embodiments will be described.

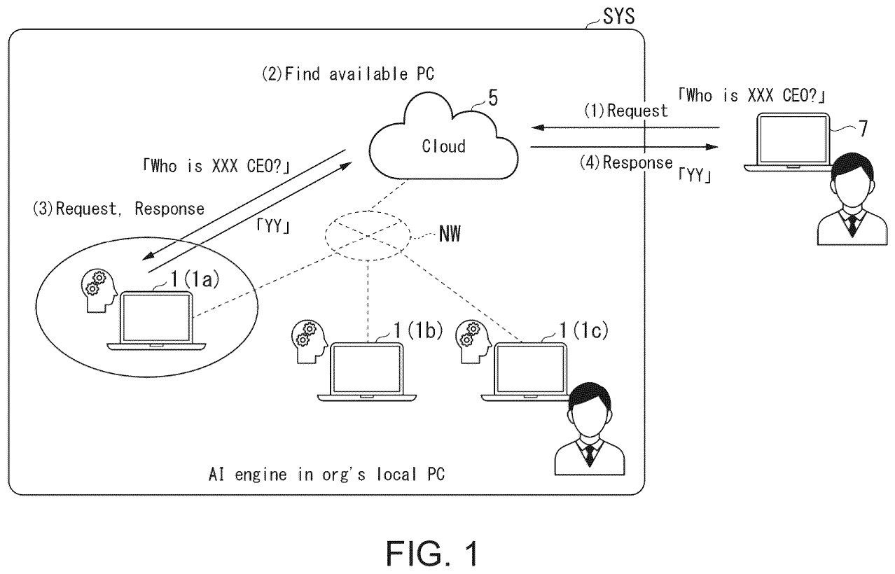

FIG. 1 is a configuration diagram for describing the overview of the information processing system according to one or more embodiments. An information processing system SYS illustrated in FIG. 1 includes plural information processing apparatuses 1, and a cloud server 5 connected to the plural information processing apparatuses 1 through a communication network NW.

The information processing apparatuses 1 are, for example, local PCs (Personal Computers) within an organization (within a company). In this figure, three representative information processing apparatuses 1a, 1b, and 1c are illustrated, but tens to hundreds of information processing apparatuses 1 may be provided according to the number of users (for example, employees).

A program for processing a heavy task such as a trained AI (Artificial Intelligence) model is distributed to the plural information processing apparatuses 1. Although the heavy task is not limited to processing using the AI model, it is assumed in one or more embodiments that an AI engine to execute processing using the AI model such as a large language model (LLM) is distributed in a manner available to each information processing apparatus 1. When a user is absent, each information processing apparatus 1 makes a transition to a standby state. The standby state is a state in which at least part of system processing is limited. For example, the standby state is a state in which at least the screen of a display unit 110 is turned off (screen off), but a state in which the AI model is ready for use in response to a request from the cloud server 5.

A client terminal 7 is a terminal using the information processing system SYS, which is a PC, a smartphone, or the like. The client terminal 7 may also be an apparatus similar to the information processing apparatuses 1 in the information processing system SYS, but it will be described as the client terminal 7 to distinguish from the information processing apparatuses 1 in the information processing system SYS. The overview of processing in the information processing system SYS will be described below.
(1) The cloud server 5 accepts a request for a question to AI (for example, “Who is XXX CEO?”) from the client terminal 7.
(2) The cloud server 5 finds an available information processing apparatus 1 from among the plural information processing apparatuses 1. Specifically, the cloud server 5 extracts and selects an information processing apparatus 1 in the standby state due to the absence of a user from among the plural information processing apparatuses 1.
(3) The cloud server 5 makes a request to the AI model of the selected information processing apparatus 1 in the standby state (for example, the information processing apparatus 1a) for the question to the AI (for example, “Who is XXX CEO?”) accepted from the client terminal 7. The information processing apparatus 1 that receives the request responds to the cloud server 5 with the execution result (for example, “YY”) of the AI model on the question (for example, “Who is XXX CEO?”).
(4) Based on the response from the information processing apparatus 1, the cloud server 5 sends back, to the client terminal 7, the execution result (for example, “YY”) of the AI model on the question to the AI (for example, “Who is XXX CEO?”) accepted from the client terminal 7.

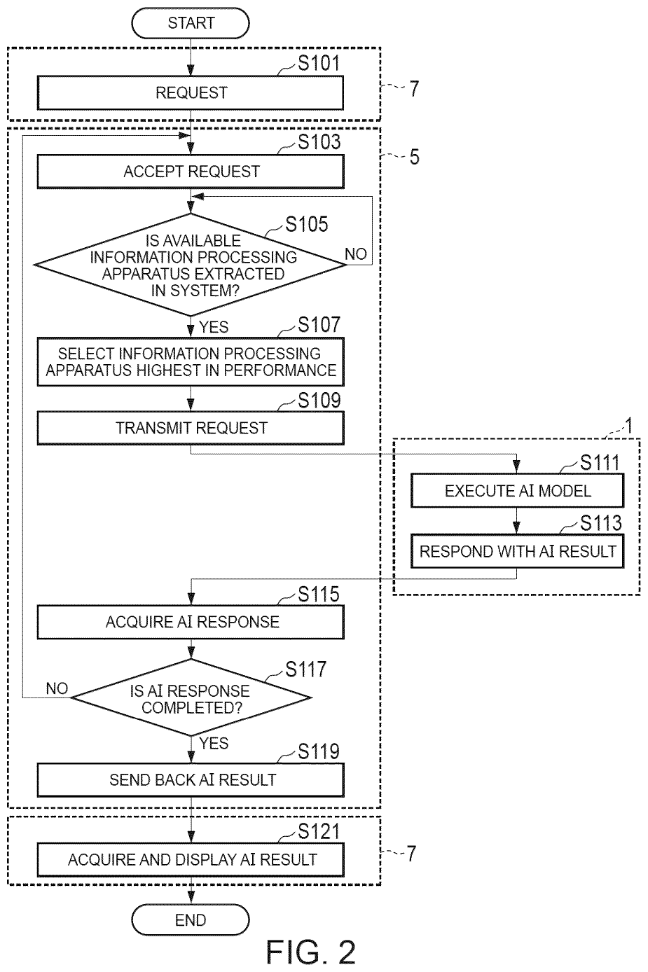

Referring next to FIG. 2, a processing flow in the information processing system SYS will be described.

FIG. 2 is a flowchart illustrating an example of processing in the information processing system according to one or more embodiments.
(Step S101) The client terminal 7 sends, to the cloud server 5, a request for a question (for example, “Who is XXX CEO?”) to the AI. Then, the procedure proceeds to step S103.
(Step S103) When accepting, from the client terminal 7, the request for the question (for example, “Who is XXX CEO?”) to the AI, the cloud server 5 proceeds to step S105.
(Step S105) The cloud server 5 extracts an available information processing apparatus 1 from among the plural information processing apparatuses 1 connected to the cloud server 5 in the information processing system SYS. The available information processing apparatus 1 is an information processing apparatus 1 that is making the transition to the standby state due to the absence of a user as described above. When making the transition to the standby state, each information processing apparatus 1 notifies the cloud server 5 of the transition, and hence the cloud server 5 can extract the information processing apparatus 1 in the standby state. When one or more available information processing apparatuses 1 are extracted (step S105: YES), the cloud server 5 proceeds to step S107. Note that, when any available information processing apparatus 1 cannot be extracted (step S105: NO), the cloud server 5 performs the process in step S105 again.
(Step S107) The cloud server 5 selects an information processing apparatus 1 highest in performance from among the available information processing apparatuses 1. For example, information about the performance of each information processing apparatus 1 is prestored in a list on the cloud server 5, and when plural available information processing apparatuses 1 are extracted in step S105, the cloud server 5 refers to the list to select an information processing apparatus 1 highest in performance from among the available information processing apparatuses 1. Then, the cloud server 5 proceeds to step S109.
(Step S109) The cloud server 5 transmits, to the information processing apparatus 1 selected in step S107, the request for the question to the AI (for example, “Who is XXX CEO?”) accepted from the client terminal 7. Then, the procedure proceeds to step S111.
(Step S111) The information processing apparatus 1 that receives the request executes processing on the question (for example, “Who is XXX CEO?”) using the AI model. Then, the information processing apparatus 1 proceeds to step S113.
(Step S113) The information processing apparatus 1 responds to the cloud server 5 with the execution result of the processing using the AI model. Here, when the processing is completed, the information processing apparatus 1 responds to the cloud server 5 with the completed execution result, while when the processing is interrupted halfway through, the information processing apparatus 1 responds to the cloud server 5 with an execution result of halfway processing. Here, the case where the processing is interrupted halfway through is, for example, a case where the user comes back while the information processing apparatus 1 is executing the processing, stops the processing, and causes the information processing apparatus 1 to return from the standby state. Then, the procedure proceeds to step S115.
(Step S115) The cloud server 5 acquires the response from the information processing apparatus 1, and proceeds to step S117.
(Step S117) The cloud server 5 determines whether or not the response acquired from the information processing apparatus 1 is the execution result of the completed processing. When determining that the response is an execution result of halfway processing (that is, that the processing is incomplete) (step S117: NO), the cloud server 5 returns to step S103, and accepts the execution result of halfway processing as a request to the AI model. Then, the cloud server 5 extracts available information processing apparatuses 1, and sends the request to an information processing apparatus 1 highest in performance (step S105 to step S109). Thus, the information processing apparatus 1 that receives the request takes over the halfway processing to execute the processing using the AI model.

On the other hand, when determining that the response acquired from the information processing apparatus 1 is the execution result of the completed processing (step S117: YES), the cloud server 5 proceeds to step S119.
(Step S119) Based on the response acquired from the information processing apparatus 1, the cloud server 5 sends back, to the client terminal 7, the execution result of the AI model (for example, “YY”) on the question to the AI (for example, “Who is XXX CEO?”) accepted from the client terminal 7.
(Step S121) The client terminal 7 acquires and displays the execution result of the AI model (for example, “YY”) acquired from the cloud server 5.

### [Configuration of Information Processing Apparatus]

Next, the configuration of the information processing apparatus 1 that executes processing using the AI model when making the transition to the standby state in the information processing system SYS will be described in detail.

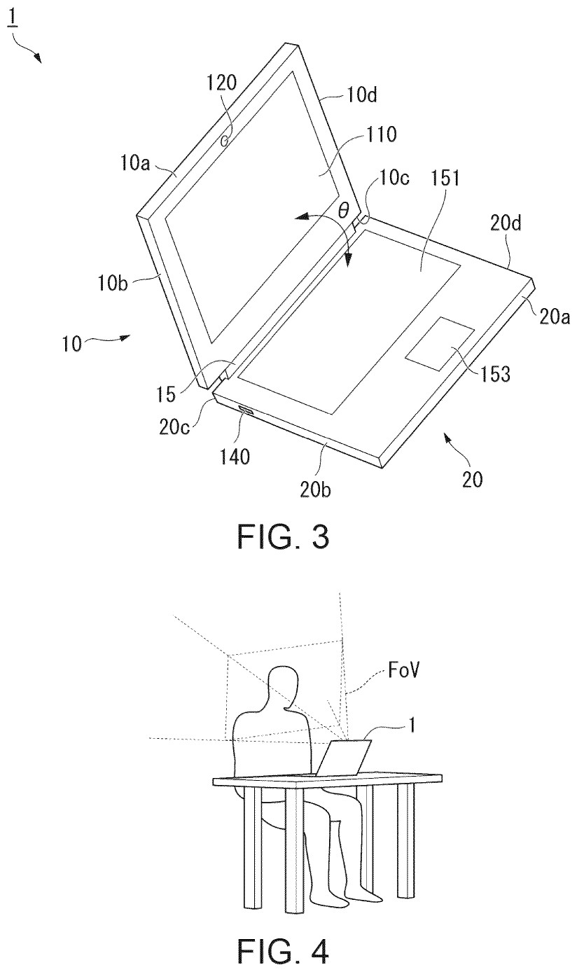

FIG. 3 is a perspective view illustrating a configuration example of the appearance of the information processing apparatus 1 according to one or more embodiments.

The information processing apparatus 1 is, for example, a laptop (clamshell) PC (Personal Computer). The information processing apparatus 1 includes a first chassis 10, a second chassis 20, and a hinge mechanism 15. The first chassis 10 and the second chassis 20 are joined by using the hinge mechanism 15. The first chassis 10 is rotatable around an axis of rotation formed by the hinge mechanism 15 relative to the second chassis 20. An open angle by the rotation between the first chassis 10 and the second chassis 20 is denoted as “θ” in FIG. 3.

The first chassis 10 is also called A cover or a display chassis. The second chassis 20 is also called C cover or a system chassis. In the following description, faces on which the hinge mechanism 15 is provided among side faces of the first chassis 10 and the second chassis 20 are referred to as side faces 10c and 20c, respectively. Among the side faces of the first chassis 10 and the second chassis 20, faces opposite to the side faces 10c and 20c are referred to as side faces 10a and 20a, respectively. In this figure, the direction from the side face 20a toward the side face 20c is referred to as “rear,” and the direction from the side face 20c toward the side face 20a is referred to as “front.” The rear right and the rear left are referred to as “right” and “left,” respectively. The left side faces of the first chassis 10 and the second chassis 20 are referred to as side faces 10b and 20b, respectively, and the right faces are referred to as side faces 10d and 20d, respectively. Further, a state where the first chassis 10 and the second chassis 20 overlap each other and are completely closed (a state of open angle θ=0°) is referred to as a “closed state.” Surfaces of the first chassis 10 and the second chassis 20 on the face-to-face sides in the closed state are referred to as respective “inner surfaces,” and surfaces opposite to the inner surfaces are referred to as “outer surfaces.” Further, a state opposite to the closed state, where the first chassis 10 and the second chassis 20 are open, is referred to as an “open state.”

The appearance of the information processing apparatus 1 in FIG. 3 illustrates an example of the open state. The open state is a state where the side face 10a of the first chassis 10 and the side face 20a of the second chassis 20 are separated. In the open state, the respective inner surfaces of the first chassis 10 and the second chassis 20 appear. The open state is one of states where a user uses the information processing apparatus 1, and the information processing apparatus 1 is often used in a state where the open angle is typically about θ=100° to 130°. Note that the range of open angles θ to be the open state can be determined arbitrarily according to the range of angles rotatable by the hinge mechanism 15, or the like.

The display unit 110 is provided on the inner surface of the first chassis 10. The display unit 110 is configured to include a liquid crystal display (LCD) or an organic EL (Electro Luminescence) display, and the like. Further, an imaging unit 120 is provided in a peripheral area of the display unit 110 on the inner surface of the first chassis 10. For example, the imaging unit 120 is arranged on the side of the side face 10a in the peripheral area of the display unit 110. Note that the position at which the imaging unit 120 is arranged is just an example, and it may be elsewhere as long as the imaging unit 120 can be directed in a direction facing a display screen of the display unit 110.

In the open state, the imaging unit 120 images a predetermined imaging range in the direction to face the display screen of the display unit 110 (that is, in front of the information processing apparatus 1). The predetermined imaging range is an angle-of-view range defined by an image sensor included in the imaging unit 120 and an optical lens provided in front of the imaging surface of the image sensor. For example, the imaging unit 120 can capture an image including a person (user) present in front of (on the front side of) the information processing apparatus 1.

Further, a power button 140 is provided on the side face 20b of the second chassis 20. The power button 140 is an operating element used by the user to give an instruction to power on or power off, make a transition from the standby state to a normal operating state, make a transition from the normal operating state to the standby state, or the like. The normal operating state is an operating state of a system capable of executing processing without being particularly limited, which corresponds, for example, to S0 state defined in the ACPI (Advanced Configuration and Power Interface) specification.

Further, a keyboard 151 and a touch pad 153 are provided on the inner surface of the second chassis 20 as input devices to accept user operation input. Note that a touch sensor may also be provided as an input device instead of or in addition to the keyboard 151 and the touch pad 153, or a mouse and an external keyboard may be connected. When the touch sensor is provided, an area corresponding to the display screen of the display unit 110 may be constructed as a touch panel for accepting operations. Further, a microphone used to input voice may be included in the input devices.

Note that, in the closed state where the first chassis 10 and the second chassis 20 are closed, the display unit 110 and the imaging unit 120 provided on the inner surface of the first chassis 10, and the keyboard 151 and the touch pad 153 provided on the inner surface of the second chassis 20 are covered with each other's chassis surfaces, and put in a state of being disabled from fulfilling the functions.

The information processing apparatus 1 executes HPD (Human Presence Detection) processing to detect a person present in front of the information processing apparatus 1 based on a captured image captured by the imaging unit 120.

FIG. 4 is a diagram illustrating an example of a person detection range of the information processing apparatus 1 according to one or more embodiments. In the illustrated example, a detection range FoV (Field of View: detection viewing angle) in front of the information processing apparatus 1 is a person-detectable range.

The detection range FoV corresponds to an imaging angle of view at which the information processing apparatus 1 performs imaging. For example, the information processing apparatus 1 detects a face area with a face captured therein and an angle of the face from a captured image captured by the imaging unit 120. For example, when a face area is detected from the captured image, the information processing apparatus 1 determines that a person is present. Further, the information processing apparatus 1 determines the orientation of the face based on the angle of the face detected from the captured image.

The information processing apparatus 1 controls the operating state of the system of the information processing apparatus 1 depending on the presence or absence of a person by the HPD processing. For example, when a person is present in front of the information processing apparatus 1, the information processing apparatus 1 controls the operating state to the normal operating state, while when no person is present in front of the information processing apparatus 1, the information processing apparatus 1 controls the operating state to the standby state.

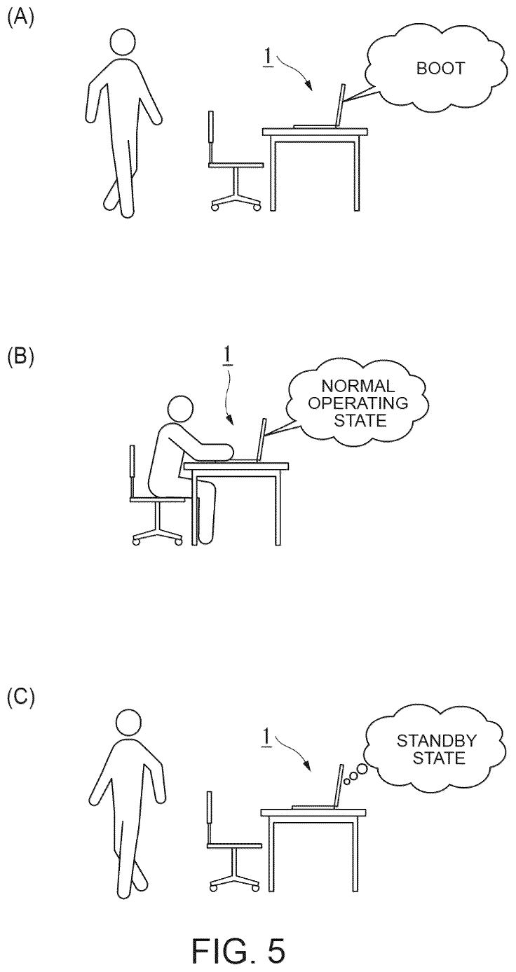

FIG. 5 is a diagram for describing an overview of HPD processing of the information processing apparatus 1 according to one or more embodiments. The information processing apparatus 1 detects a person present in front of the information processing apparatus 1 by the HPD processing to control the operating state of the system of the information processing apparatus 1 based on the presence or absence of a person. For example, as illustrated in FIG. 5(A), when detecting a change from a state where no person is present in front of the information processing apparatus 1 (Absence) to a state where a person is present (Presence) in the standby state, that is, when detecting that a person has approached the information processing apparatus 1 (Approach), the information processing apparatus 1 automatically returns to the normal operating state. Further, as illustrated in FIG. 5(B), in a state where a person is present in front of the information processing apparatus 1 (Presence) in the normal operating state, the information processing apparatus 1 continues the normal operating state. Further, as illustrated in FIG. 5(C), when detecting a change from the state where the person is present in front of the information processing apparatus 1 (Presence) to the state where no person is present (Absence), that is, when detecting that the person has left the information processing apparatus 1 (Leave), the information processing apparatus 1 causes the system to make the transition to the standby state.

Further, in the HPD processing, the information processing apparatus 1 determines the orientation of a face by detecting the angle of the face of a person present in front of the information processing apparatus 1, and when it can be determined that the person is not looking at the screen of the display unit 110, the screen brightness is reduced to save power. In the following, processing (Dimming processing) to reduce the screen brightness by this HPD processing is called “screen brightness reduction processing.”

Further, in the following, the original screen brightness before being reduced is called “standard brightness,” and the screen brightness reduced from the standard brightness is called “low brightness.” The low brightness is a brightness at least lower than the standard brightness. However, the lower the brightness, the more the effect of power saving will increase. For example, the low brightness may be about 0 to 10% of the standard brightness.

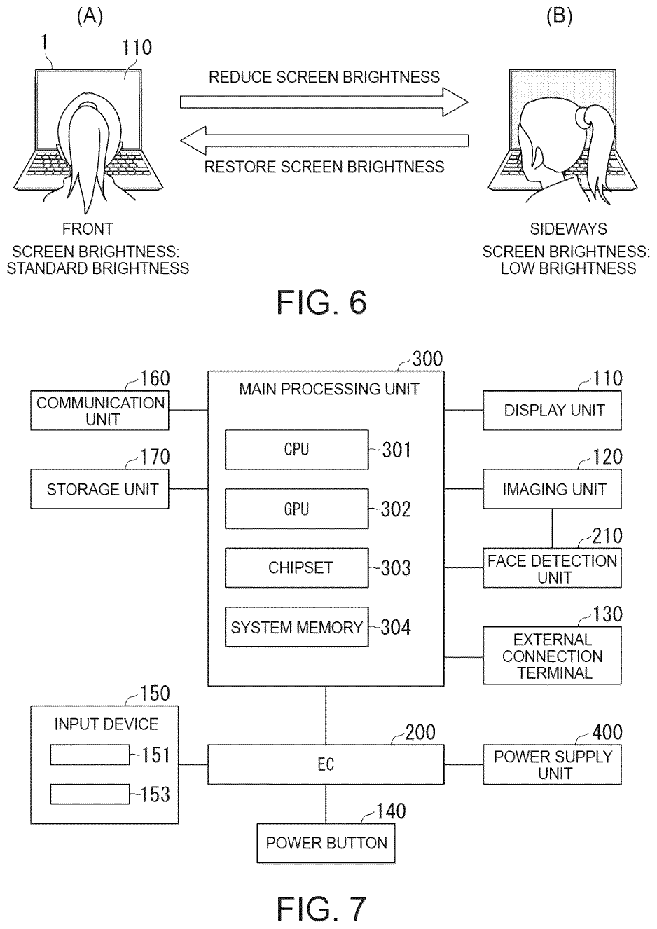

FIG. 6 is a diagram illustrating an example of screen brightness reduction processing according to one or more embodiments. For example, the information processing apparatus 1 determines whether or not a face is facing a direction of the information processing apparatus 1 (the direction of the display unit 110 and the imaging unit 120) based on the angle of the face of a person (user) present in front of the information processing apparatus 1. Here, the orientation of the face is an orientation corresponding to the rotation angle of the face in the left-and-right direction or the up-and-down direction. In the following, a state where the face is facing the direction of the information processing apparatus 1 (the direction of the display unit 110 and the imaging unit 120) is assumed to be a state where the face is facing forward toward the information processing apparatus 1.

FIG. 6(A) illustrates the state where the face is facing forward toward the information processing apparatus 1, and it can be determined that the person is looking at the screen of the display unit 110. Therefore, the information processing apparatus 1 controls the screen brightness of the display unit 110 to the standard brightness. On the other hand, FIG. 6(B) illustrates a state where the face is not facing forward toward the information processing apparatus 1 (for example, facing sideways), and it can be determined that the person is not looking at the screen of the display unit 110. Therefore, when the orientation of the face changes from the state illustrated in FIG. 6(A) to the state illustrated in FIG. 6(B), the information processing apparatus 1 reduces the screen brightness of the display unit 110 from the standard brightness to the low brightness. Further, when the orientation of the face changes from the state illustrated in FIG. 6(B) to the state illustrated in FIG. 6(A), the information processing apparatus 1 restores the screen brightness of the display unit 110 from the low brightness to the standard brightness.

### [Hardware Configuration of Information Processing Apparatus]

FIG. 7 is a schematic block diagram illustrating an example of the hardware configuration of the information processing apparatus 1 according to one or more embodiments. In FIG. 7, components corresponding to respective units in FIG. 3 are given the same reference numerals. The information processing apparatus 1 is configured to include the display unit 110, the imaging unit 120, an external connection terminal 130, the power button 140, an input device 150, a communication unit 160, a storage unit 170, an EC (Embedded Controller) 200, a face detection unit 210, a main processing unit 300, and a power supply unit 400.

The display unit 110 displays display data (images) generated based on system processing executed by the main processing unit 300, processing of an application program(s) running on the system processing, and the like.

The imaging unit 120 captures an image of an object within the predetermined imaging range (angle of view) in the direction (frontward) to face the inner surface of the first chassis 10, and outputs the captured image to the main processing unit 300 and the face detection unit 210. For example, the imaging unit 120 includes a visible light camera (RGB camera) for capturing an image using visible light and an infrared camera (IR camera) for capturing an image using infrared light.

Note that the imaging unit 120 may be configured to include either one of the visible light camera and the infrared camera, or may be configured to include both of the visible light camera and the infrared camera.

The external connection terminal 130 is a connection terminal for connecting to an external device. For example, the external connection terminal 130 is an HDMI (registered trademark) terminal, a USB Type-C terminal, or the like.

The power button 140 outputs, to the EC 200, an operation signal according to a user operation. The input device 150 is an HID (input unit) that accepts user input, which is configured to include, for example, the keyboard 151 and the touch pad 153. In response to accepting operations on the keyboard 151 and the touch pad 153, the input device 150 outputs, to the EC 200, operation signals indicative of operation contents.

The communication unit 160 is connected to other devices communicably through a wireless or wired communication network NW to transmit and receive various data. For example, the communication unit 160 is configured to include a wired LAN interface such as Ethernet (registered trademark), a wireless LAN interface such as Wi-Fi (registered trademark), and the like. As an example, the communication unit 160 performs data communication with the cloud server 5 through the communication network NW.

The storage unit 170 is configured to include storage media, such as an HDD (Hard Disk Drive) or an SSD (Solid State Drive), a RAM (Random Access Memory), and a ROM (Read Only Memory). The storage unit 170 stores an OS, device drivers, various programs such as applications, and various data acquired by the operation of the programs.

The power supply unit 400 supplies power to each unit according to the operating state of each unit of the information processing apparatus 1. The power supply unit 400 includes a DC(Direct Current)/DC converter. The DC/DC converter converts the voltage of DC power, supplied from an AC (Alternate Current)/DC adapter or a battery (battery pack), to a voltage required for each unit. The power with the voltage converted by the DC/DC converter is supplied to each unit through each power system. For example, the power supply unit 400 supplies power to each unit through each power system based on a control signal input from the EC 200.

The EC 200 is a microcomputer configured to include a CPU (Central Processing Unit), a RAM (Random Access Memory), a ROM (Read Only Memory), an I/O (Input/Output) logic circuit, and the like. The CPU of the EC 200 reads a control program (firmware) prestored in the own ROM, and executes the read control program to fulfill the functionality. The EC 200 operates independently of the main processing unit 300 to control the operation of the main processing unit 300 and manage the operating state of the main processing unit 300. Further, the EC 200 is connected to the power button 140, the input device 150, the power supply unit 400, and the like.

For example, the EC 200 communicates with the power supply unit 400 to acquire information on a battery state (remaining battery capacity, and the like) from the power supply unit 400 and to output, to the power supply unit 400, a control signal or the like in order to control the supply of power according to the operating state of each unit of the information processing apparatus 1. Further, the EC 200 acquires operation signals from the power button 140 and the input device 150, and outputs, to the main processing unit 300, an operation signal related to processing of the main processing unit 300 among the acquired operation signals.

The face detection unit 210 is configured to include a processor to process image data of a captured image captured by the imaging unit 120. The face detection unit 210 acquires the image data of the captured image captured by the imaging unit 120, and temporarily stores the acquired image data in a memory. The memory in which the image data is stored may be a system memory 304, or an unillustrated memory in the face detection unit 210.

For example, the face detection unit 210 processes the image data of the captured image acquired from the imaging unit 120 to perform face detection processing for detecting a face area (an area of a face image) and the orientation (angle) of the face from the captured image.

As the face detection method, any detection method using a face detection algorithm for detecting a face based on facial feature information, trained data (learned model) subjected to machine learning based on the facial feature information, a face detection library, or the like can be applied. Further, the face detection unit 210 extracts the positions of facial landmarks such as the left eye, right eye, nose, mouth, chin, and the like of a face to detect the orientation (angle) of the face from the extracted positional relationship.

Further, the face detection unit 210 outputs the detection results by the HPD processing based on the detection results of the face area and face angle detected in the face detection processing. For example, the face detection unit 210 outputs, to the main processing unit 300, the detection results based on the presence or absence of a person and the orientation of a face.

The main processing unit 300 is configured to include a CPU (Central Processing Unit) 301, a GPU (Graphic Processing Unit) 302, a chipset 303, and the system memory 304, where processing of various application programs is executable on the OS (Operating System) by system processing based on the OS.

The CPU 301 is a processor that executes processing based on a BIOS program, processing based on the OS program, processing based on application programs running on the OS, and the like. For example, the CPU 301 executes processing to cause the system to return from the standby state to the normal operating state, processing to cause the system to make the transition from the normal operating state to the standby state, and the like. As an example, in the HPD processing based on the face detection results by the face detection unit 210 described above, the CPU 301 executes processing for causing the system to make the transition to the standby state, processing for causing the system to return from the standby state, the screen brightness reduction processing for reducing the screen brightness of the display unit 110, and the like.

The GPU 302 is connected to the display unit 110. The GPU 302 executes image processing under the control of the CPU 301 to generate display data. The GPU 302 outputs the generated display data to the display unit 110.

The chipset 303 has a function as a memory controller, a function as an I/O controller, and the like. For example, the chipset 303 controls reading data from and writing data to the system memory 304, the storage unit 170, and the like by the CPU 301 and the GPU 302. Further, the chipset 303 controls input/output of data from the communication unit 160, the display unit 110, and the EC 200. Further, the chipset 303 has a function as a sensor hub. For example, the chipset 303 acquires the detection results by the face detection processing acquired from the face detection unit 210, and the like.

The system memory 304 is used as a reading area of a program executed by the CPU 301 and a working area to write processed data. Further, the system memory 304 temporarily stores image data of a captured image captured by the imaging unit 120.

Note that the CPU 301, the GPU 302, and the chipset 303 may be integrated as one processor, or some or each of them may be configured as an individual processor, respectively.

### [Functional Configuration of Information Processing Apparatus]

Next, the functional configuration of the information processing apparatus 1 to execute processing using the AI model in response to a request from the cloud server 5 will be described.

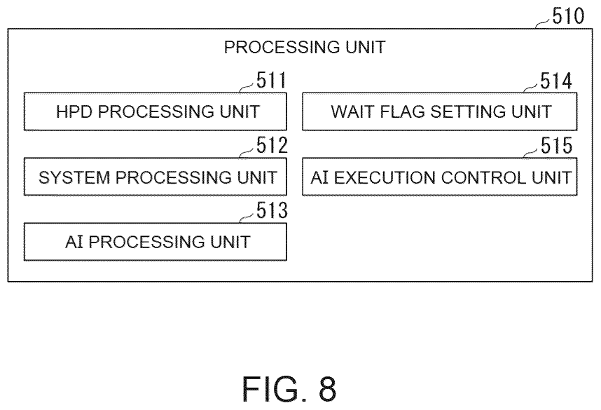

FIG. 8 is a schematic block diagram illustrating an example of the functional configuration of the information processing apparatus 1 according to one or more embodiments. The information processing apparatus 1 includes a processing unit 510 as a functional component implemented by a processor such as the face detection unit 210, the CPU 301, the chipset 303, or the EC 200 executing programs. The processing unit 510 includes an HPD processing unit 511, a system processing unit 512, an AI processing unit 513, a wait flag setting unit 514, and an AI execution control unit 515.

The HPD processing unit 511 detects the presence or absence of a person based on the detection result by the face detection unit 210. For example, when a face area is detected from a captured image, the HPD processing unit 511 determines that a person is present, and outputs information (Presence=true) indicating that a person is present. On the other hand, when no face area is detected from the captured image, the HPD processing unit 511 outputs information (Presence=false) indicative of the absence of a person.

Further, the HPD processing unit 511 determines whether or not a face is facing forward toward the information processing apparatus 1 based on the detection result by the face detection unit 210, and outputs the determination result. For example, when determining that the face is facing forward toward the information processing apparatus 1, the HPD processing unit 511 outputs information (Attention=true) indicating that the face is paying attention to the information processing apparatus 1. On the other hand, when determining that the face is not facing forward toward the information processing apparatus 1, the HPD processing unit 511 outputs information (Attention=false) indicating that the face is not paying attention to the information processing apparatus 1.

The system processing unit 512 is a functional component implemented by the CPU 301 executing a system program and a program such as an application running on the system. For example, the system processing unit 512 controls the operating state of the system such as system bootup, the transition to the standby state, shutdown, or the like.

As an example, the system processing unit 512 controls the operating state of the system based on the detection result of the presence or absence of a person by the HPD processing unit 511. Specifically, for example, when acquiring information (Presence=true) indicative of the presence of a person from the HPD processing unit 511 in the standby state, the system processing unit 512 returns the system from the standby state and makes the transition to the normal operating state (return from the standby state). Further, in the normal operating state, when acquiring information (Presence=false) indicative of the absence of a person from the HPD processing unit 511, the system processing unit 512 causes the system to make the transition to the standby state (for example, Screen off).

Further, when the presence of a person is determined by the HPD processing unit 511, the system processing unit 512 executes the screen brightness reduction processing based on the determination result of whether or not the face is facing forward toward the information processing apparatus 1. For example, when acquiring information (Attention=false) indicating that the face is not paying attention to the information processing apparatus 1, the system processing unit 512 reduces the screen brightness of the display unit 110 from the standard brightness to the low brightness, and causes the system to make the transition to the standby state. Further, when acquiring information (Attention=true) indicating that the face is paying attention to the information processing apparatus 1 after that, the system processing unit 512 restores the screen brightness of the display unit 110 from the low brightness to the standard brightness (return from the standby state).

The AI processing unit 513 is equipped with an AI engine that executes processing using an AI model such as a large language model (LLM). The AI processing unit 513 inputs, to the AI model, a request for a question to the AI model (for example, “Who is XXX CEO?”) received from the cloud server 5 through the communication network NW, and outputs the execution result (for example, “YY”).

When the system processing unit 512 causes the system to make the transition to the standby state, the wait flag setting unit 514 transmits a flag indicative of being on standby to the cloud server 5 through the communication network NW. By receiving this flag, the cloud server 5 can determine which information processing apparatus 1 is in the standby state.

Further, after transmitting the flag indicative of being on standby to the cloud server 5, when the presence of a person is detected by the HPD processing unit 511, the wait flag setting unit 514 resets the flag indicative of being on standby.

Specifically, for example, in a case where the flag indicative of being on standby is “1,” and a flag indicative of not being on standby is “0,” when the system processing unit 512 causes the system to make the transition to the standby state, the wait flag setting unit 514 transmits the flag “1” indicative of being on standby to the cloud server 5. After that, when the presence of a person is detected by the HPD processing unit 511, the wait flag setting unit 514 resets the flag by transmitting the flag “0” to the cloud server 5. The cloud server 5 can determine which information processing apparatus 1 is in the standby state depending on whether this flag is “1” or “0.”

In response to transmitting the flag “1” indicative of being on standby from the wait flag setting unit 514 to the cloud server 5, when acquiring a request for a question (for example, “Who is XXX CEO?”) (an execution request for AI processing) to the AI from the cloud server 5, the AI execution control unit 515 causes the AI processing unit 513 to start the execution of processing using the AI model. When the AI processing by the AI processing unit 513 is completed, the AI execution control unit 515 transmits the completed execution result (for example, “YY”) to the cloud server 5.

Further, when the presence of a person is detected by the HPD processing unit 511 while executing the AI processing by the AI processing unit 513, the AI execution control unit 515 stops the execution, and transmits, to the cloud server 5, the execution result obtained before the stop and incomplete information indicating that the AI processing is incomplete.

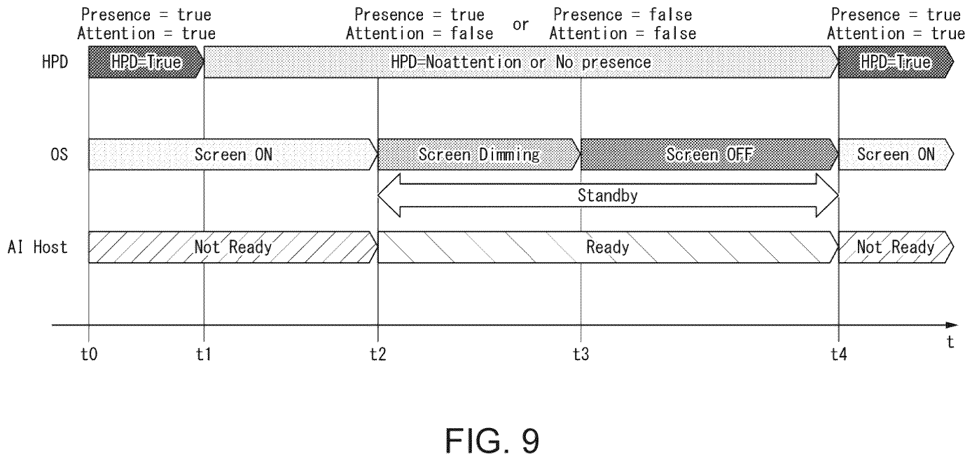

FIG. 9 is a timing chart illustrating an example of control by the processing unit 510 according to one or more embodiments. In this figure, relationships among the HPD processing, the state of the system (OS), and the ready-for-use state of the information processing apparatus 1 (AI host) are illustrated on a timeline by plotting time (t) on the horizontal axis.

At time t0, in a state where the HPD processing unit 511 is outputting “Presence=true” and “Attention=true,” that is, in a state where a person is present and facing forward (HPD=True), the system processing unit 512 is turning on the screen of the display unit 110 (Screen ON).

At time t1, it is assumed that the HPD processing unit 511 outputs “Presence=true” and “Attention=false,” or “Presence=false” and “Attention=false,” that is, that a person is present but not facing forward (HPD=No attention) or no person is present (HPD=No presence). In this case, at time t2 after a certain period of time has elapsed in that state, the system processing unit 512 reduces the screen brightness of the display unit 110 to the low brightness (Screen Dimming).

Further, when the HPD processing unit 511 continues to output “Presence=true” and “Attention=false” or “Presence =false” and “Attention=false,” the system processing unit 512 turns off the screen of the display unit 110 (Screen OFF) at time t3.

At time t4, when the HPD processing unit 511 outputs “Presence=true” and “Attention=true,” that is, when a person is present and facing forward (HPD=True), the system processing unit 512 turns on the screen of the display unit 110 (Screen ON).

In this case, since the information processing apparatus 1 is in the standby state during a period from time t2 to time t4, this period is a period during which the AI engine of the information processing apparatus 1 (AI host) is ready for use. When making the transition to the standby state at time t2, the information processing apparatus 1 transmits the flag indicative of being on standby to the cloud server 5, and resets the flag when returning from the standby state at time t4.

Next, the operation of AI host processing in which the processing unit 510 of the information processing apparatus 1 executes AI processing in response to a request from the cloud server 5 will be described.

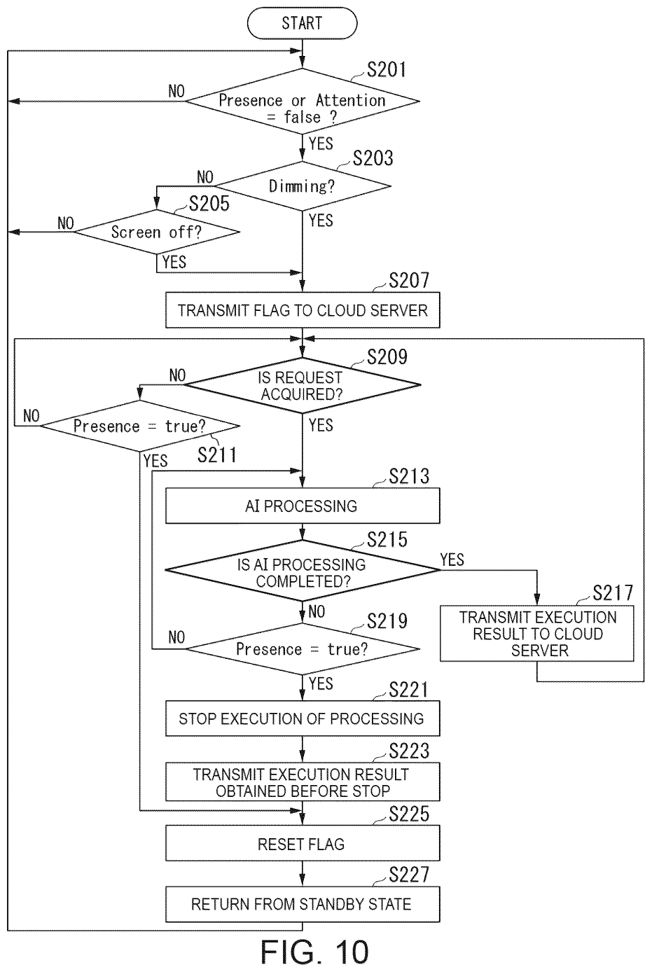

FIG. 10 is a flowchart illustrating an example of host processing in the information processing apparatus 1 according to one or more embodiments.
(Step S201) The processing unit 510 determines whether the detection result of the HPD processing is “Presence=false” or “Attention=false.” When determining that the detection result is “Presence=True” and “Attention=true” (step S201: NO), the processing unit 510 performs the process in step S201 again. On the other hand, when determining that the detection result is “Presence=false” or “Attention=false” (step S201: YES), the processing unit 510 proceeds to step S203.
(Step S203) The processing unit 510 determines whether or not the screen brightness of the display unit 110 is reduced to the low brightness (Dimming). When determining that the screen brightness of the display unit 110 is reduced (Dimming) (step S203: YES), the processing unit 510 proceeds to step S207. On the other hand, when determining that the screen brightness of the display unit 110 is not reduced (not Dimming) (step S203: NO), the processing unit 510 proceeds to step S205.
(Step S205) The processing unit 510 determines whether or not the screen of the display unit 110 is turned off (Screen off). When determining that the screen of the display unit 110 is not turned off (No Screen off) (step S205: NO), the processing unit 510 returns to step S201. On the other hand, when determining that the screen of the display unit 110 is turned off (Screen off) (step S205: YES), the processing unit 510 proceeds to step S207.
(Step S207) The processing unit 510 transmits the flag indicative of being on standby to the cloud server 5 through the communication network NW. Then, the processing unit 510 proceeds to step S209.
(Step S209) The processing unit 510 determines whether or not a request for a question (for example, “Who is XXX CEO?”) to the AI is acquired from the cloud server 5. When determining that the request is not acquired (step S209: NO), the processing unit 510 proceeds to step S211 to wait for the request from the cloud server 5.
(Step S211) The processing unit 510 determines whether or not the detection result of the HPD processing is “Presence=True.” When determining that the detection result is “Presence=True” (step S211: YES), the processing unit 510 proceeds to step S225. On the other hand, when determining that the detection result is not “Presence=True” (step S211: NO), the processing unit 510 returns to step S209.

When determining in step S209 that the request is acquired (step S209: YES), the processing unit 510 proceeds to step S213.
(Step S213) The processing unit 510 inputs, to the AI model, the request for the question to the AI model (for example, “Who is XXX CEO?”) received from the cloud server 5 to start executing AI processing. Then, the processing unit 510 proceeds to step S215.
(Step S215) The processing unit 510 determines whether or not the AI processing is completed. When determining that the AI processing is completed (step S215: YES), the processing unit 510 proceeds to step S217. On the other hand, when determining that the AI processing is not completed (step S215: NO), the processing unit 510 proceeds to step S219.
(Step S217) When the AI processing is completed, the processing unit 510 transmits the completed execution result (for example, “YY”) to the cloud server 5. Then, the processing unit 510 returns to step S209 to wait for a next request.
(Step S219) The processing unit 510 determines whether or not the detection result of the HPD processing is “Presence=True.” When determining that the detection result is not “Presence=True” (step S219: NO), the processing unit 510 returns to step S213 to continue the AI processing. On the other hand, when determining that the detection result of the HPD processing is “Presence=True” (step S219: YES), the processing unit 510 proceeds to step S221.
(Step S221) The processing unit 510 stops the execution of the AI processing, and proceeds to step S223.
(Step S223) The processing unit 510 transmits, to the cloud server 5, the execution result obtained before the stop and incomplete information indicating that the AI processing is incomplete. Then, the processing unit 510 proceeds to step S225.
(Step S225) The processing unit 510 resets the flag indicative of being on standby. Then, the processing unit 510 proceeds to step S227.
(Step S227) The processing unit 510 returns from the standby state to make the transition to the normal operating state. Then, the processing unit 510 returns to step S201.

### [Summary of Embodiment]

As described above, the information processing apparatus 1 according to one or more embodiments includes: the communication unit 160 that performs data communication with the cloud server 5 (an example of a server) through the communication network NW; the system memory 304 (an example of a memory) that temporarily stores a program of a system; a processor that executes processing of the system based on the program stored in the system memory 304; and the imaging unit 120 (an example of a detection sensor) for detecting the presence or absence of a person in the detection range FoV (an example of a predetermined detection range). Here, the processor is the CPU 301, the chipset 303 included in the main processing unit 300, the EC 200, or the like. When the system becomes the standby state, the processing unit 510 as a functional component implemented by the processor such as the face detection unit 210, the CPU 301, the chipset 303, or the EC 200 executing a program(s) transmits the flag indicative of being on standby from the communication unit 160 to the cloud server 5 through the communication network NW. Further, when acquiring a request (execution request) for AI processing (an example of specific processing) from the cloud server 5 in response to transmitting the flag, the processing unit 510 starts executing the AI processing. Further, when the presence of a person is detected in the detection range FoV using the imaging unit 120 (Presence=true) while executing the AI processing, the processing unit 510 stops the execution, and transmits the execution result obtained before the stop and incomplete information indicating that the AI processing is incomplete from the communication unit 160 to the cloud server 5 through the communication network NW.

Thus, since the information processing apparatus 1 can perform processing as a host in the case of the standby state in response to the request from the cloud server 5, and detect that a user has come back before the user touches the information processing apparatus 1 to stop the processing, the information processing apparatus 1 can prevent processing from slowing down due to insufficient resources when the user uses the information processing apparatus 1. Therefore, the information processing apparatus 1 can reduce the impact on performance when locally executing heavy-load processing.

Further, when the presence of a person is detected in the detection range FoV using the imaging unit 120 while not executing AI processing, the processing unit 510 resets the flag.

Thus, when the user is using the information processing apparatus 1, the information processing apparatus 1 can notify the cloud server 5 that processing cannot be performed as a host in response to a request from the cloud server 5. Therefore, the cloud server 5 can make a request for the execution of processing to an information processing apparatus 1 except for information processing apparatuses 1 in use from among the plural information processing apparatuses 1.

Further, when the presence of a person is detected in the detection range FoV using the imaging unit 120 while executing the AI processing, the processing unit 510 causes the system to return from the standby state after stopping the execution, and resets the flag.

Thus, since the information processing apparatus 1 performs processing in the case of the standby state in response to a request from the cloud server 5, and when the user comes back, the information processing apparatus 1 returns to a state in which the user can use the information processing apparatus 1 after stopping the processing, the information processing apparatus 1 can prevent processing from slowing down due to insufficient resources when the user uses the information processing apparatus 1. Therefore, the information processing apparatus 1 can reduce the impact on performance when locally executing heavy-load processing.

Further, the information processing apparatus 1 includes the display unit 110 that performs display based on the system processing. For example, when causing the system to make the transition to the standby state, the processing unit 510 turns off the screen of the display unit 110 (Screen OFF), while when causing the system to return from the standby state, the processing unit 510 turns on the screen of the display unit 110 (Screen ON).

Thus, since the information processing apparatus 1 performs processing as a host in response to a request from the cloud server 5 in the case of Screen OFF (that is, when the user is not using the information processing apparatus 1), and when the user comes back, the information processing apparatus 1 turns on the screen to return to a state in which the user can use the information processing apparatus 1 after stopping the processing, the information processing apparatus 1 can prevent processing from slowing down due to insufficient resources when the user uses the information processing apparatus 1.

Further, when the presence of a person is detected in the detection range FoV using the imaging unit 120, the processing unit 510 further determines whether or not a face of the person is facing forward (an example of a specific direction). For example, when determining that the face of the person present in the detection range FoV is not facing forward, the processing unit 510 transmits the flag to the cloud server 5 after causing the system to make the transition to the standby state (for example, after reducing the screen brightness). Further, when determining that the face of the person present in the detection range FoV is turned to the front while executing the AI processing, the processing unit 510 returns the system from the standby state after stopping the execution.

Thus, since the information processing apparatus 1 performs processing as a host in response to a request from the cloud server 5 when the user is not facing forward (that is, when the user is not using the information processing apparatus 1), and when the user uses the information processing apparatus 1, the information processing apparatus 1 returns to a state in which the user can use the information processing apparatus 1 after stopping the processing, the information processing apparatus 1 can prevent processing from slowing down due to insufficient resources when the user uses the information processing apparatus 1.

Further, the information processing apparatus 1 includes the display unit 110 that performs display based on the system processing. Further, the front (the example of the specific direction) mentioned above is a direction toward the information processing apparatus 1. When causing the system to make the transition to the standby state, the processing unit 510 reduces the screen brightness of the display unit 110, while when returning the system from the standby state, the processing unit 510 restores the screen brightness of the display unit 110 to the original screen brightness before being reduced.

Thus, since the information processing apparatus 1 performs processing as a host in response to a request from the cloud server 5 when the screen brightness is reduced because the user is not facing forward (that is, when the user is not using the information processing apparatus 1), and when the user uses the information processing apparatus 1, the information processing apparatus 1 returns to a state in which the user can use the information processing apparatus 1 after stopping the processing, the information processing apparatus 1 can prevent processing from slowing down due to insufficient resources when the user uses the information processing apparatus 1.

Further, the AI processing (the example of the specific processing) is relatively heavy-load processing, which is processing executable on the plural information processing apparatuses 1 while taking over halfway processing in response to a request (execution request) from the cloud server 5.

Thus, when executing heavy-load processing (for example, AI processing) in response to a request from the cloud server 5, the information processing apparatus 1 performs processing only during a period of the standby state, and interrupts the processing before returning from the standby state so that another information processing apparatus 1 in the standby state can take over the processing. Therefore, even in the case of heavy-load processing (for example, AI processing), since the processing can be executed on plural local information processing apparatuses 1 while taking over the processing without using processing (for example, a cloud AI service) of the cloud server 5, the heavy-load processing (for example, AI processing) can be executed at a low cost.

Further, a control method for the information processing apparatus 1 according to one or more embodiments includes: a step in which, when the system becomes the standby state, the processing unit 510, as a functional component implemented by a processor such as the face detection unit 210, the CPU 301, the chipset 303, or the EC 200 executing a program(s), transmits the flag indicative of being on standby from the communication unit 160 to the cloud server 5 through the communication network NW; a step in which, when acquiring a request (execution request) for AI processing (the example of the specific processing) from the cloud server 5 in response to transmitting the flag, the processing unit 510 starts executing the AI processing; a step in which, when the presence of a person is detected in the detection range FoV using the imaging unit 120 (Presence=true) while executing the AI processing, the processing unit 510 stops the execution; and a step of causing the processing unit 510 to transmit an execution result before the stop and incomplete information indicating that the AI processing is incomplete from the communication unit 160 to the cloud server 5 through the communication network NW.

Thus, since the control method for the information processing apparatus 1 can perform processing on the information processing apparatus 1 as a host in the case of the standby state in response to a request from the cloud server 5, and detect that the user has come back before the user touches the information processing apparatus 1 to stop the processing, the control method can prevent processing from slowing down due to insufficient resources when the user uses the information processing apparatus 1. Therefore, the control method for the information processing apparatus 1 can reduce the impact on performance when locally executing heavy-load processing.

Further, according to one or more embodiments, since a response when AI processing is executed on the information processing apparatus 1 can be recorded as a log in the cloud server 5, it can be used to improve the AI model.

Further, according to one or more embodiments, since information processing apparatuses 1 that are not used, for example, within an organization (within a company) can be used effectively to execute heavy-load processing (for example, AI processing), when the organization (the company) has offices in countries, the information processing apparatuses 1 at the offices in countries can be used by taking advantage of the time difference between countries. For example, during working hours in Japan, an information processing apparatus 1 or the like unused in the United States of America can be selected and used effectively to execute processing.

While embodiments of this invention have been described in detail above with reference to the accompanying drawings, the specific configurations are not limited to those described above, and design changes and the like are included without departing from the scope of this invention. For example, the respective components described in the above embodiment can be combined arbitrarily.

Further, in the aforementioned embodiment, the example of using the imaging unit 120 as the detection sensor for detecting the presence or absence of a person is given, but a ToF (Time of Flight) sensor may also be used instead of the imaging unit 120. Further, an ultrasonic sensor may be used as the detection sensor for detecting the presence or absence of a person. For example, as the ultrasonic sensor, unillustrated speaker and microphone included in the information processing apparatus 1 may be used.

Further, the CPU 301 and the chipset 303 may be configured as individual processors, or may be integrated as one processor. Further, the CPU 301 and the GPU 302 may be configured as individual processors, or may be integrated as one processor. Further, each unit included in the main processing unit 300 may be configured as one single chip such as an SoC (System-on-a-Chip).

Further, in the aforementioned embodiment, the example in which the face detection unit 210 is provided separately from the CPU 301 and the chipset 303 is given, but some or all of the functions of the face detection unit 210 may be provided in the chipset 303, or may be provided in a processor integrated with the CPU 301 or the chipset 303. For example, the CPU 301, the chipset 303, and the face detection unit 210 may be configured as individual processors, or may be integrated as one processor. Further, some or all of the functions of the face detection unit 210 may be provided in the EC 200. Further, some functions of the system processing unit 512 may be provided in the EC 200.

Note that the information processing apparatus 1 described above has a computer system therein. Then, a program for implementing the function of each component included in the information processing apparatus 1 described above may be recorded on a computer-readable recording medium so that the program recorded on this recording medium is read into the computer system and executed to perform processing in each component included in the information processing apparatus 1 described above. Here, the fact that “the program recorded on the recording medium is read into the computer system and executed” includes installing the program on the computer system. It is assumed that the “computer system” here includes the OS and hardware such as peripheral devices and the like. Further, the “computer system” may also include two or more computers connected through networks including the Internet, WAN, LAN, and a communication line such as a dedicated line. Further, the “computer-readable recording medium” means a portable medium such as a flexible disk, a magneto-optical disk, a flash ROM, or a CD-ROM, or a storage device such as a hard disk built in the computer system. Thus, the recording medium with the program stored thereon may be a non-transitory recording medium such as the CD-ROM.

Further, a recording medium internally or externally provided to be accessible from a delivery server for delivering the program is included as the recording medium. Note that the program may be split into plural pieces, downloaded at different timings, respectively, and then united in each component included in the information processing apparatus 1, or delivery servers for delivering respective split pieces of the program may be different from one another. Further, it is assumed that the “computer-readable recording medium” includes a medium on which the program is held for a given length of time, such as a volatile memory (RAM) inside a computer system as a server or a client when the program is transmitted through a network. The above-mentioned program may also be to implement some of the functions described above. Further, the program may be a so-called differential file (differential program) capable of implementing the above-described functions in combination with a program(s) already recorded in the computer system.

Further, some or all of the functions provided by the information processing apparatus 1 in one or more embodiments described above may be realized as an integrated circuit such as LSI (Large Scale Integration). Each function may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

Further, the information processing apparatus 1 of the aforementioned embodiment is not limited to the laptop PC, which may also be a desktop PC or the like, for example.

### DESCRIPTION OF SYMBOLS

1 information processing apparatus
5 cloud server
10 first chassis
20 second chassis
15 hinge mechanism
110 display unit (internal display)
120 imaging unit
130 external connection terminal
140 power button
150 input device
151 keyboard
153 touch pad
160 communication unit
170 storage unit
200 EC
210 face detection unit
300 main processing unit
301 CPU
302 GPU
303 chipset
304 system memory
400 power supply unit
510 processing unit
511 HPD processing unit
512 system processing unit
513 AI processing unit
514 wait flag setting unit
515 AI execution control unit

What is claimed is:

1. An information processing apparatus comprising:
a communication unit configured to perform data communication with a server through a communication network;
a memory configured to temporarily store a program of a system;
a processor configured to execute processing of the system based on the program stored in the memory; and
a detection sensor configured to detect presence or absence of a person in a predetermined detection range, wherein
when the system becomes a standby state, the processor transmits a flag indicative of being on the standby state from the communication unit to the server through the communication network,
when acquiring an execution request for specific processing from the server in response to transmitting the flag, the processor starts execution of the specific processing, and
when the presence of a person is detected in the detection range using the detection sensor while executing the specific processing, the processor stops the execution, and transmits, from the communication unit to the server through the communication network, an execution result before the stop and incomplete information indicating that the specific processing is incomplete.

2. The information processing apparatus according to claim 1, wherein when the presence of a person is detected in the detection range using the detection sensor while not executing the specific processing, the processor resets the flag.

3. The information processing apparatus according to claim 1, wherein when the presence of a person is detected in the detection range using the detection sensor while executing the specific processing, the processor causes the system to return from the standby state after stopping the execution, and resets the flag.

4. The information processing apparatus according to claim 3, further comprising
a display unit configured to perform display based on processing of the system, wherein
when causing the system to transition to the standby state, the processor turns off a screen of the display unit, and
when causing the system to return from the standby state, the processor turns on the screen of the display unit.

5. The information processing apparatus according to claim 1, wherein
when the presence of a person is detected in the detection range using the detection sensor, the processor further determines whether or not a face of the person is facing a specific direction,
when determining that the face of the person present in the detection range is not facing the specific direction, the processor transmits the flag to the server after causing the system to transition to the standby state, and
when determining that the face of the person present in the detection range is turned in the specific direction while executing the specific processing, the processor causes the system to return from the standby state after stopping the execution.

6. The information processing apparatus according to claim 5, further comprising
a display unit configured to perform display based on processing of the system, wherein
the specific direction is a direction to the information processing apparatus,
when causing the system to transition to the standby state, the processor reduces screen brightness of the display unit,
when causing the system to return from the standby state, the processor restores the screen brightness of the display unit to screen brightness before being reduced.

7. The information processing apparatus according to claim 1, wherein the specific processing is relatively heavy-load processing and can be executed on a plurality of information processing apparatuses while taking over halfway processing in response to the execution request from the server.

8. A control method for an information processing apparatus including: a communication unit configured to perform data communication with a server through a communication network; a memory configured to temporarily store a program of a system; a processor configured to execute processing of the system based on the program stored in the memory; and a detection sensor configured to detect presence or absence of a person in a predetermined detection range, the control method comprising:
a step of transmitting a flag indicative of being on standby from the communication unit to the server through the communication network when the system becomes a standby state;
a step of starting execution of the specific processing when acquiring an execution request for specific processing from the server in response to transmitting the flag;
a step of stopping the execution when the presence of a person is detected in the detection range using the detection sensor while executing the specific processing; and
a step of transmitting, from the communication unit to the server through the communication network, an execution result before the stop and incomplete information indicating that the specific processing is incomplete.
